(19) United States
(12) Patent Application Publication
(10) Pub. No.: US 2015/0088373 A1
(43) Pub. Date: Mar. 26, 2015

(54) OPTICAL COMMUNICATIONS AND OBSTACLE SENSING FOR AUTONOMOUS VEHICLES

(71) Applicant: The Boeing Company, Seal Beach, CA (US)

(72) Inventor: Donald F. Wilkins, O'Fallon, MO (US)

(73) Assignee: The Boeing Company, Seal Beach, CA (US)

(21) Appl. No.: 14/034,130

(22) Filed: Sep. 23, 2013

(51) Int. Cl. G06G 7/70

(52) U.S. Cl. CPC G06G 7/70
USPC 701/36

(57) ABSTRACT

A system and method is provided that permits optical communication between vehicles or vehicles and transportation fixtures by modulating an optical source located on either a vehicle or a transportation fixture. The optical source is modulated to include information about the vehicle or fixture. The modulated optical signal is then transmitted from the optical source to an environment external the vehicle or fixture. The system may further include sensors for receiving input optical information signals from the external environment that contains information about external sources, such as other vehicles or fixtures. The system further includes a processor for controlling signal modulation and processing input optical information received from the vehicle sensors.

### BACKGROUND OF THE INVENTION

1. Field of the Invention

The present invention relates to a communication system and in particular to a communication system that utilizes modulating light sources to transmit information between surrounding vehicles and/or between vehicles and transportation fixtures.

2. State of the Art

The design and use of autonomous, or driverless, automobiles has become increasingly popular and poses a tremendous market opportunity. At present, autonomous vehicle technology can reduce traffic collisions, commute time, energy consumption, transportation costs, and the need for complex infrastructure. Autonomous vehicle technology can have an even larger impact in developing countries. Just as cell phones allowed developing countries to avoid building expensive land-line infrastructures, autonomous vehicle technology can also eliminate the need of developing countries to avoid investing in and constructing western-style road systems.

At present, an important challenge in autonomous vehicle technology is the ability to communicate with, and receive information about, the surrounding environment of the vehicle. Current approaches to solve this problem have included integrating radios, lasers, cameras and other sensors into the autonomous vehicle.

In particular, most automotive manufactures look to radio frequencies (“RF”) to provide vehicle-to-vehicle communications. One problem with the RF systems is the omnidirectional radiation of information and its ability to receive information from any direction. While RF has many advantages, it is subject to “spooking” and provides an entry point into the vehicle control systems. In this later instance, researchers have used a RF link to externally manipulate a vehicle's air-conditioning system. In spooking, a malicious operator could feed false information into the system. For example, he could feed in information that a number of vehicles are stopped, inducing a traffic jam.

Another problem with current systems is that they are very costly. Current estimates on known autonomous automobiles are approximately three hundred thousand dollars. Additionally, these current autonomous automobile designs are not very pleasing to the eye. Moreover, another problem with known autonomous vehicle technology is existing vehicles are difficult to retrofit and will take decades to implement known autonomous vehicle technology approaches. Furthermore, a more significant current drawback is safety. If one portion of the system fails, the autonomous vehicle will become unsafe.

As such, a need exists for a communication system that permits vehicle information to be exchanged between vehicles and roadside or transportation fixtures that is less expensive to design and install. A need further exists for inexpensive systems to function as a either a primary communication systems or secondary communication systems to provide back-up in the event of failure by the primary system. In this manner, the safety of autonomous vehicle systems may be greatly increased and more affordable. Lastly, a need further exists for a system with a narrower field to make it more difficult to inject false information into the system.

### SUMMARY

A system is provided that permits optical communication between vehicles or vehicles and roadside furniture and fixtures (e.g., lights, signs, road markings) (collectively “transportation fixtures” or “fixtures”) by modulating an optical source located on either a vehicle or a transportation fixture and transmitting the modulated light source to an environment external the vehicle or furniture. The modulated light source transmits information pertaining to the vehicle or fixture where the light source is located for receipt by a surrounding vehicle or fixture. The system further provides for vehicles and transportation fixtures to include cameras for receiving the modulated light being transmitted from surrounding vehicles and transportation fixtures.

The modulating light of the present invention can be incorporated into head lights and tail lights and accompanied by cameras for sensing information about the vehicle surroundings, including detecting modulated light sources being transmitted from surrounding vehicles and transportation fixtures. Together, through the use of the lights and cameras, an external optical communication system is created that can provide a variety of simultaneous functions, including, but not limited to head light illumination, braking and turning indications, speed indicators, inter-vehicle communications, vehicle to roadside fixtures and 3D renditions of the surround. Information such as location, speed, direction, brake activation and turning information can be exchanged. Using this information, accidents can be anticipated, braking can be initiated, speeds can be altered, air bag deployment can be activated (in advance of the accident), among many other things.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a block diagram of one example of a system architecture of the present invention as it may be incorporated into a vehicle.

FIG. 2 is a block diagram of one example of a system architecture as it may be incorporated into a transportation fixture.

FIG. 3 is system diagram showing one example of communication flow between two vehicles.

FIG. 4 is system diagram showing one example of communication flow between a vehicle and a transportation fixture.

FIG. 5 is a system diagram showing another example of communication flow between a vehicle and a transportation fixture.

FIG. 6 is yet another system diagram showing another example of communication flow between a vehicle and a transportation fixture.

FIG. 7 is a flow diagram illustrating the steps required to facilitate communication between two vehicles or a vehicle and a fixture.

### DETAILED DESCRIPTION

A system and method is provided that permits optical communication between vehicle or vehicles and roadside furniture and fixtures (e.g., lights, signs, road markings) (collectively “transportation fixtures” or “fixtures”) by modulating an optical light source located on either a vehicle or a transportation fixture and transmitting the modulated light source to an environment external the vehicle or fixture. The system and method may also be implemented to receive obstacle avoidance information from the external environment and/or to establish communication links with surrounding objects.

The system may include one or more optical sources, a modulator, one or more optical sensors, processor, and, optionally, a navigation system. In an example of operation, the system may perform a process that includes modulating the optical source to create a modulated optical signal, transmitting the modulated optical signal from the optical source to the external environment of a vehicle, receiving an input optical information signal from the external environment, and process the input optical information signal to produce navigation information that the vehicle may utilize to navigate the vehicle autonomously.

While the present invention may be particularly useful in driverless or autonomous automobiles, those skilled in the art will appreciate that the system may be utilized in any transportation vehicle, including, but not limited to automobiles, trucks, buses, motorcycles, aircraft, boats, or any other device that is put in motion and could benefit from sensing and/or communicating with its external environment via optical communication. Further, while the invention is described in connection with autonomous vehicles, those skilled in the art will recognize that one or more of the features of the invention may be utilized in connection with any vehicle, whether or not autonomous, to enhance safety and/or provide redundancy to current vehicle safety systems.

In general, an autonomous vehicle is a vehicle capable of sensing its external environment and moving and navigating through the external environment without human input. Autonomous vehicles may be land-based, airworthy, or water based vehicles. As far as land-based autonomous vehicles, there is a major push to incorporate autonomous vehicle technology into the automobile and trucking industry. As such, terms as “autonomous automobile”, “autonomous car,” “robotic car,” “driverless car,” “self-driving car,” etc. have been generally utilized interchangeably for land-based autonomous vehicles.

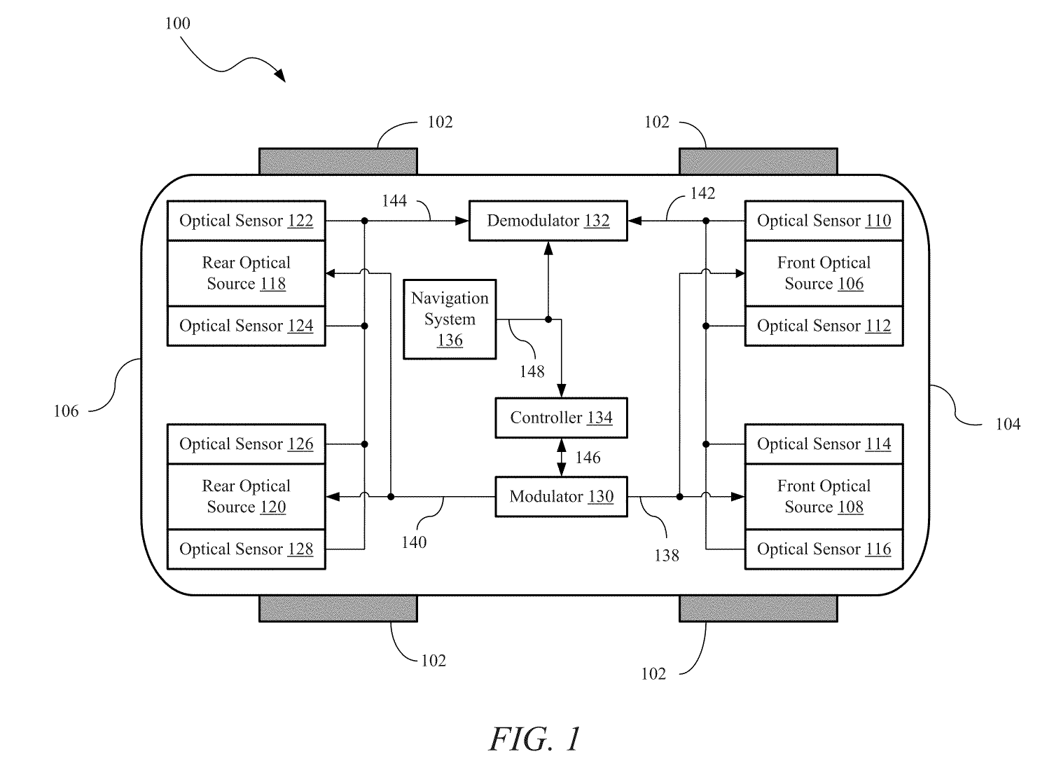

In FIG. 1, a block diagram 100 of an example of an implementation of an Improved Autonomous Vehicle (“IAV”) 100 is shown in accordance with the present invention. In this example, the IAV 100 may be a ground vehicle with four wheels 102 such as an automobile, truck, or bus. The autonomous vehicle 100 may include a front 104 and back 106. The front 104 may include a first front optical source 106 and a second front optical source 108. The front 104 may also include four front optical sensors 110, 112, 114, and 116. Similarly, the back 106 may include a first rear optical source 118, second rear optical source 120, and four rear optical sensors 122, 124, 126, and 128. The autonomous vehicle 100 may also include a modulator 130, demodulator 132, controller 134, and, optionally, a navigation system 136, which may include a dead reckoning or global positioning system.

In this example, the modulator 130 may be in signal communication with the first and second front optical sources 106 and 108 and first and second rear optical sources 118 and 120 via signal paths 138 and 140, respectively. Similarly, the demodulator 132 may be in signal communication with the four front optical sensors 110, 112, 114, and 116 via signal path 142 and the four rear optical sensors 122, 124, 126, and 128 via signal path 144. The controller 134 may be in signal communication with the modulator 130, via signal path 146, and with the demodulator 132 and navigation system 136 via signal path 148, respectively.

As an example, the front optical sources 106 and 108 may be a pair of headlights and the rear optical sources 118 and 120 may be a pair of taillights. Additionally, the optical sensors 110, 112, 114, 116, 122, 124, 126, and 128 may be digital imagers such as, for example, charge-coupled device (“CCD”) or complementary metal-oxide-semiconductor (“CMOS”) active pixel sensors. It is appreciated that CCD and CMOS imagers are generally referred to as digital image sensors or digital cameras. The optical sensors 110, 112, 114, 116, 122, 124, 126, and 128 are devices capable of receiving input optical information signals from the external environment. The input optical information signals may be signals that include modulated optical signals or that include image information of the external environment as of a result of the optical sensors 110, 112, 114, 116, 122, 124, 126, and 128 capturing images (i.e., taking pictures) of the external environment.

If the input optical information signal received by an optical sensor 110, 112, 114, 116, 122, 124, 126, and 128 is a modulated optical signal, the signal is passed to the demodulator 132, which demodulates the modulated optical signal and produces a demodulated input signal that is passed to the controller 134. The controller 134 then processes the sensor information and optionally passes it to the navigation system 136 or alters other vehicle systems based upon the processed data (e.g., apply the brakes, deploy the air bag, cause the vehicle to alter direction or speed). The data may be received in the form of a demodulated input optical information signal or may be in the form of an image signal. Further, when the data is a demodulated input optical information signal, the processor may establish a communication link with an external object that sent the modulated input optical information signal to initiate communication with the external object. The external object may be another vehicle or a transportation fixture such as, for example, a traffic signal, stop sign, speed limit sign, warning signs, etc.

Generally, only a single front optical source 106 and a single front optical sensor 110 are needed for the present invention; however, since the IAV 100 in FIG. 1 represents an example of an implementation in automobile, truck, or bus, more front optical sensors 112, 114 and 116 and an additional front optical source 108 is shown for greater performance. Similarly, only a single rear optical source 118 and a single rear optical sensor 122 are needed for the present invention; however, more rear optical sensors 124, 126 and 128 and an additional rear optical source 120 is shown for greater performance. In this example, the pair of optical sensors 110 and 112, 114 and 116, 122 and 124, and 126 and 128 are positioned near each side of each front optical source (i.e., each headlight) 106 and 108 and each rear optical source (i.e., each taillight) 118 and 120.

The controller 134 may be any type of processor capable of interfacing with and controlling the operations of the modulator 130, demodulator 132, optical sensors 110, 112, 114, 116, 122, 124, 126, and 128, and navigation system 136. The navigation system 136 is a system that receives all the sensor information from the optical sensors 110, 112, 116, 122, 124, 126, and 128 and any other sensors or location devices (not shown) such as GPS receivers, radio location systems, dead recognizing systems, image recognition system, etc. and in response produces the navigation information necessary to control the movement of the IAV 100. The navigation system 136 may be implemented in hardware, software, or both and the navigation system 136 may be part of the processor/controller 134.

In the illustrated example, all the optical sources 106, 108, 118, and 120 are devices that are capable of simultaneously producing illumination and a modulated optical signal that can be transmitted from the optical sources to an external environment of the IAV 100. As an example, the optical sources 106, 108, 118, and 120 may be light-emitting diodes (“LEDs”) light sources that are capable of transmitting the modulated light at frequencies that are high enough that the human eye is incapable of perceiving anything besides a transmission of steady light (i.e., an illuminating light). For example, the optical sources 106, 108, 118, and 120 may transmit the modulated light at a frequency close to 15 kilohertz (“KHz”), which would be perceived as a steady light source by a human eye.

Alternatively, the optical sources 106, 108, 118, and 120 may include multiple light sources per optical source 106, 108, 118, or 120 that would allow for both straight illumination (i.e., a steady light source) from one sub-light source and transmission of modulated light at another sub-light source per optical source, multiple simultaneous transmissions of modulated light (say one sub-light source at 15 KHz and another at 45 KHz), or multiple simultaneous transmissions of modulated light plus straight illumination.

Turning back to the optical sources 106, 108, 122, and 124, these optical sources may be modulated using IEEE Standard 802.15.7 using either or both PHY I or PHY III specification. The referenced PHYI and PHY III specifications are detailed in the IEEE Standards Association publication, Part 15.7: Short-Range Wireless Optical Communication Using Visible Light, which is incorporated by reference in this application in its entirety. The 802.15.7 standard defines the MAC layer and several PHY layers for short-range optical wireless communications using visible light (extending from 380 nm to 780 nm in wavelength) in optically transparent media.

In particular, PHY I is intended for outdoor usage with low data rate applications. This mode uses on-off keying (OOK) and variable pulse position modulation (VPPM) with data rates in the tens to hundreds of kb/s. PHY III is intended for applications using color-shift keying (CSK) that have multiple light sources and detectors. This mode uses CSK with data rates in the tens of Mb/s. Further, PHY I and PHY III occupy different spectral regions in the modulation-domain spectrum, with different data rates and different optical rate support, which allow for coexistence.

Regardless of which specification is utilized, modulation will be rapid enough so that the primary purposes of illumination source will not be affected. The data rates in either case will be sufficient to transmit a signal to the vehicle surrounding in a direction either ahead or behind a vehicle, or both. The modulated signal may transmit critical data about the IAV 100 to its surroundings, including but not limited to vehicle position, vehicle speed, rate of acceleration, rate of deceleration, braking information, and/or air bag deployment. GPS information may also be added to transmit location data. In other words, different information can be coded, transmitted and then later decoded by a receiving sensor (e.g., camera), demodulator and controller/processor, enabling external optical communications between vehicles and other mobile and stationary objects. The transmitted data can take many forms, including, but not limited to, audio and video data.

It is appreciated that the IAV 100 may communicate via modulated optical signals with different types of external objects that include other autonomous vehicles, roadside fixtures, law enforcement vehicles, etc. These communications would be via modulated optical signals utilizing a modulation scheme such as the one described by IEEE 802.15.7.

As mentioned earlier, the optical sensors 110, 112, 114, 116, 122, 124, 126, and 128 may also be utilized for sensing information about the IAV 100 surroundings. For example, in certain implementations, optimized optical sensors may be utilized for the detection of near infrared light that will enable the creation of 3D images of the surrounding volume of the external environment. In this example, the optical sources 106, 108, 118, and 120 may utilize structured infrared (“IR”) light to allow the optical sensors 110, 112, 114, 116, 122, 124, 126, and 128 to receive images that the controller 134 may utilize to create 3D images of certain parts of the external environment and to calculate depth and surface information.

Based on the above discussion, by using both optical sources 106, 108, 118, and 120 and optical sensors 110, 112, 114, 116, 122, 124, 126, and 128 in the IAV 100, an external optical communication system is created that can provide a variety of simultaneous functions, including, but not limited to head light illumination, braking and turning indications, speed indicators, inter-vehicle communications, vehicle to roadside furniture communication and 3D renditions of surround. Information such as vehicle identification, location, speed, direction, brake activation and turning information can be exchanged with other vehicles or fixtures. Using this information, accidents can be anticipated, braking can be initiated, speeds can be altered, air bag deployment can be activated (in advance of the accident), among many other things.

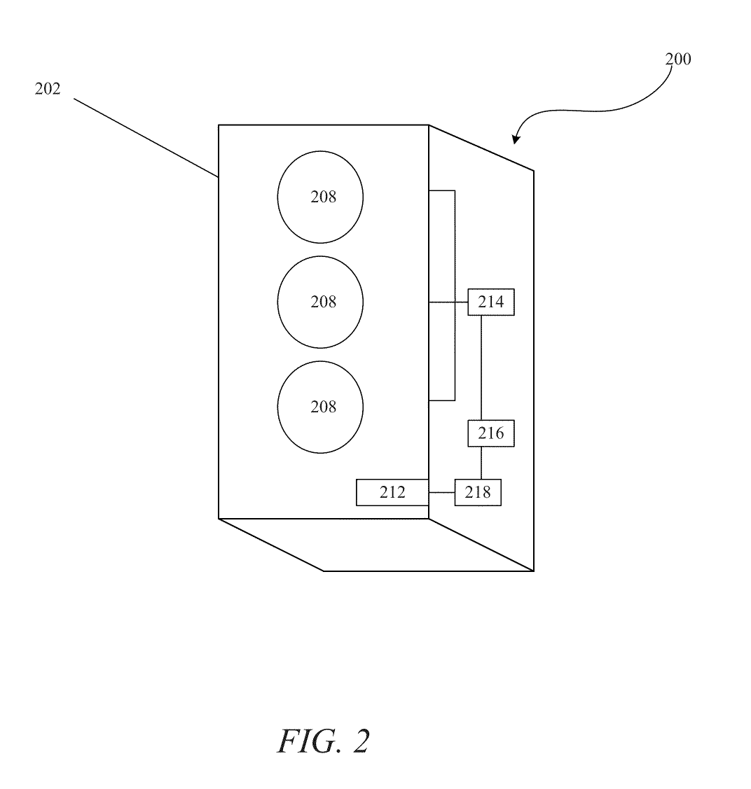

Turning to FIG. 2, FIG. 2 is a block diagram of one example of a system architecture 200 as may be incorporated into a transportation fixture, such a sign, light and other fixtures utilized to control or direct vehicle traffic. In the illustrated example, the fixture is a traffic light 202. In the example, the traffic light 202 includes three optical light sources 208 as well as an optical sensor 212. Like the system described in relation to IAV 100, the system 200 is controlled by a controller 216. A demodulator 218 is in communication with the optical sensor 212 to demodulate any modulated light sensed by the camera 212 from its surroundings. The optical lights 208 are further in communication with a modulator 214 for modulating light emitted from each signal light 208. Although the illustrated example shows the modulator 214 connected to all three traffic lights 208, those skilled in the art will recognize that only one or a select number of the lights 208 may be modulated. The modulated light may be utilized to transmit information to the surrounding environment about the signal light 202, which information may include, but not be limited to, information related to the timing of the lights 208. The optical sensor 212 may be utilized to sense approaching vehicles, as well as determine the speed of approaching vehicles. This information may be processed by the controller 216 to control the timing of the traffic lights 208 for particular intersections based upon actual traffic flow conditions.

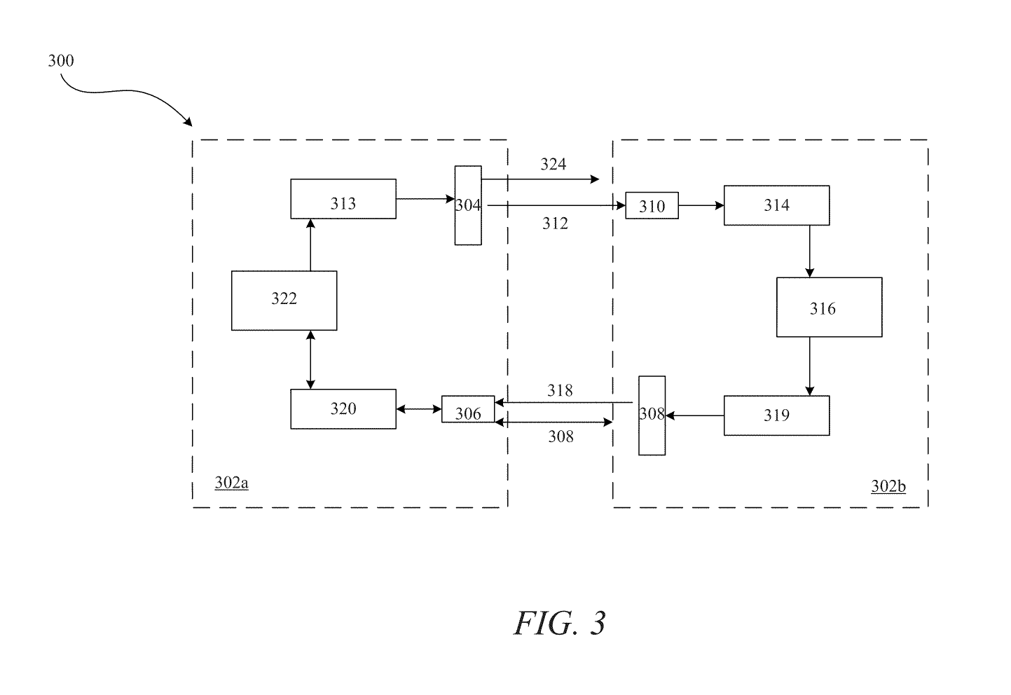

FIG. 3 is system diagram 300 showing one example of communication flow between two autonomous vehicles 302a and 302b. In this regard, although generally described in the context of two autonomous vehicles such as automobiles, the example is likewise applicable to autonomous vehicles such as airborne or aerial vehicles such as aircraft that are manned or unmanned. In this example, communication flow is illustrated between a front headlight 304 and optical sensor or camera 306 of autonomous vehicle 302a and the taillight 308 and rear camera 310 of autonomous vehicle 302b.

As the modulated light 312 is directed outward and external to the autonomous vehicle 302a from the headlight 304. Surrounding cameras 310 in surrounding autonomous vehicles 302b are used to sense the modulated light 312 produced by modulator 313. Using demodulators 314 in communication with the cameras 310, critical information about the surrounding or approaching autonomous vehicle 302a is received and processed by the controller 316. The controller 316 may then modify the autonomous vehicle 302b response or behavior based upon the information received about the surrounding environment 312. Optionally, the information received may also be passed to a navigations system (not shown) or a communication link may be established with vehicle 302a.

In the same matter that modulated light 302 is directed outward and external to the autonomous vehicle 302b from the headlight 308, modulated light 318, produced by modulator 319, is directed outward and external to the autonomous vehicle 302b from the taillight 308. Surrounding cameras 306 in surrounding vehicles 302a are used to sense the modulated light 318. Again, using demodulators 320 in communication with the cameras 306, critical information about the surrounding or approaching autonomous vehicle 302b is received and processed by the controller 322. The controller 322 may then modify the autonomous vehicle 302a response or behavior based upon the information received about the surrounding environment 318.

Optionally, the lights 304 may also utilize structured infrared light 324 to allow the cameras 306 to determine depth and surface information about the surrounding environment. In this case, light 304 can emit modulated signals 312 as well as optionally, structured infrared light 324. The infrared light 324 reflecting off a surrounding fixture may be sensed by the cameras 306 and processed through the processor 322 to create 3D images of the fixture. While the flow diagram in FIG. 3 only illustrates the structured infrared light 324 being emitted from light 304 and sensed by camera 306 of autonomous vehicle 302a, the taillight 308 and camera 310 of autonomous vehicle 302b may also be designed to perform the same functions.

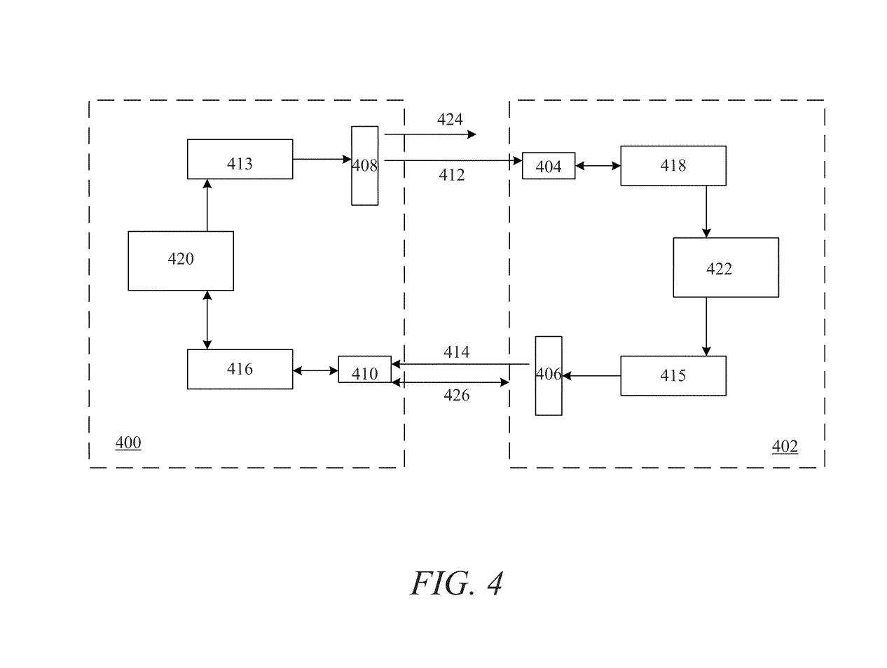

FIG. 4 is system diagram showing one example of communication flow between a vehicle 400 and a fixture 402. In this example, the fixture 402 includes both a light 406 and a optical sensor or camera 404. As such, the communication flow between the vehicle 400 and the fixture 402 is very similar to the communication flow described between the two vehicles 302a and 302b in connection with FIG. 3. The optical lights 408, 406 are modulated by modulators 413, 415, respectively, and the modulated optical signals 412, 414 are transmitted outward from both lights 408 and 406 to communicate critical information about the autonomous vehicle 400 and the fixture 402, respectively. Cameras 410, 404 in the autonomous vehicle 400 and in the fixture 402, respectively, sense the modulated light 414 and 412. The light is then demodulated by the respective demodulators 416, 418 and the information is processed by the respective controllers 420, 422. Optionally, structured infrared light 424 may be emitted from one or more of the lights 408. The reflection of which light 426 may be captured by one or more cameras 410 to create a 3D images and determine information about surrounding objects such as distance and type of object.

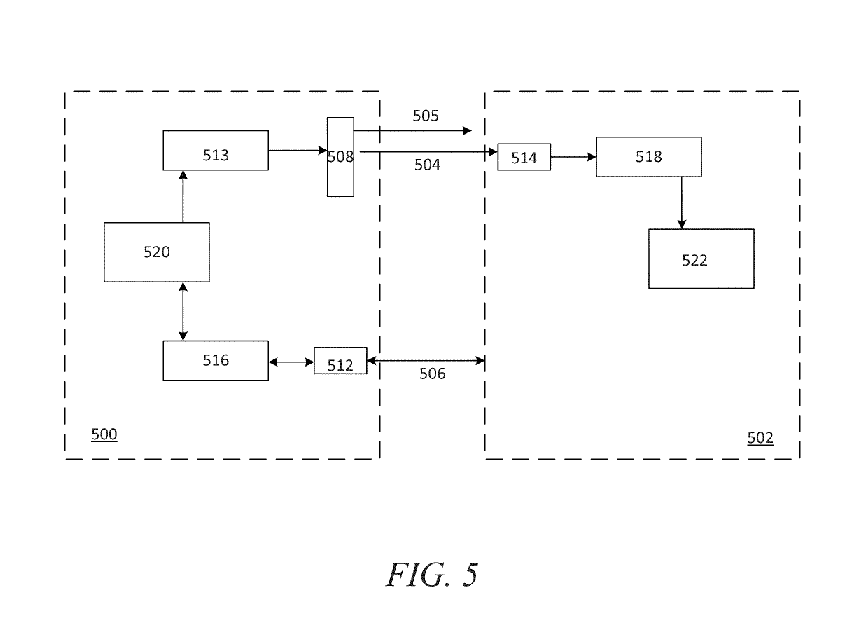

FIG. 5 is a flow diagram showing another example of communication flow between an autonomous vehicle 500 and a transportation fixture 502. In this example, the fixture 502 only includes a sensor or camera 514 and does, itself, emit modulated light. Thus, the fixture 502 is collecting and processing information about its surroundings, but is not sharing information. For example, the camera 514 may sense and process modulated lighted 504 being emitting from approaching vehicles 500. The modulated light 504 or input optical information signal is then demodulated using a demodulator 518 and then processed by controller 522. In this regard, a signal light 502 may, for example, collect information about the surround traffic to use for controlling the traffic lights or signal without providing any information to the surrounding vehicles 500 about the operation of the light.

Further, the light 508 in the autonomous vehicle 500 may transmit, in addition to a modulated light signal 504 created by modulator 513, structured infrared light 505 that can be read by an onboard optical sensor or camera 512. In this manner, the camera 512 can sense and process the detected light 506 to determine information about its surroundings, for example, if the autonomous vehicle 500 is approaching a lighted intersection. The sensor 506 may also capture other input optical information signals from other sources (not shown), which may include modulated light from other vehicles. The captured light may be demodulated and processed by the demodulator 516 and the controller 520.

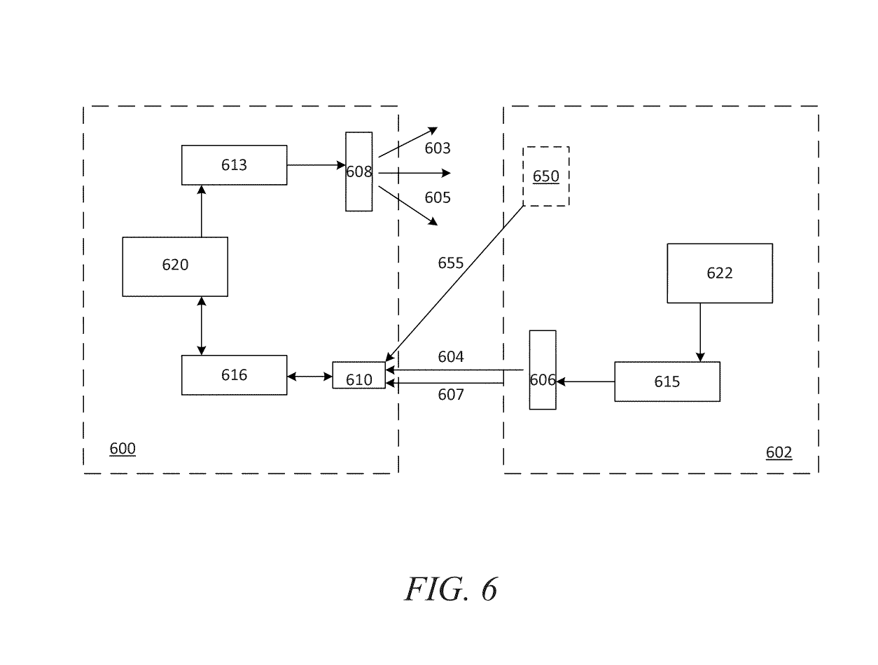

FIG. 6 is yet another flow diagram showing another example of communication flow between an autonomous vehicle 600 and a transportation fixture 602. In this example, the transportation fixture 602 does not include a sensor. Thus, the communication is passive communication, rather an active communication, as illustrated in FIGS. 1-4 above. The fixture 602 only includes a light 606 and a modulator 615 for modulating light to create a modulated optical signal to be transmitted externally via the optical light 606. In this example, the transportation fixture 602 could be a sign indicating the speed of the road, an approaching speed change (e.g., school zone) or other information relevant to the traffic flow or vehicle operation in the particular surrounding environment. In these examples, it is not important for the fixtures 602 to provide two-way communication with the vehicles 500 as the information that the fixtures are conveying are generally static or will not be altered by approaching vehicles 600.

As illustrated, in this example, the fixture 602 includes a light source 606, a modulator 615 and a controller 622. The autonomous vehicle 600 may detect the modulated light 604 via optical sensor or camera 610 and then demodulate the optical light signal using demodulator 118. The data is then processed by the controller 620 to determine the information being conveyed to the surround by the transportation fixture 602 using controller 622.

Like in prior examples, the vehicle 600 includes an optical light source 608 that may emit either or both a modulated optical light signal 603 or structured infrared light 506. The modulated light signal 603 is created using a modulator 613 controlled by a controller or processor 620.

Optionally, instead of a light source 608, the light source 608 could be replaced with or supplement by reflective strips 650. In this example, the reflective strips 650 could be affixed to the transportation fixture 602 to provide additional information about the road or the fixture 602. While shape recognition software could provide similar information, the systems capable of image recognition are often expensive, subject to ambient lighting conditions and do not operate at suitable speeds for highway operation. In this example, the reflective strips 650 could provide, in additional to a primary means of communication, backup communication, for example, to supplement or replace GPS information if unavailable.

The reflective strips 650, in the case of a moving instruction, could indicate the type of movement to which is relates, e.g., a stop sign or a speed limit sign. In the case of a speed limit sign, it could further provide the associated speed limitations. Additionally, the reflect strips 650 could also provide location information, giving an indication of distance from a certain point or object (i.e., a barrier ten meters from the center of the road).

In operation, light from a light source 608 or ambient light, for example, would reflect off the strip 650. The camera 610 can then sense and process the detected light 655 to determine the information being transmitted by the reflectors.

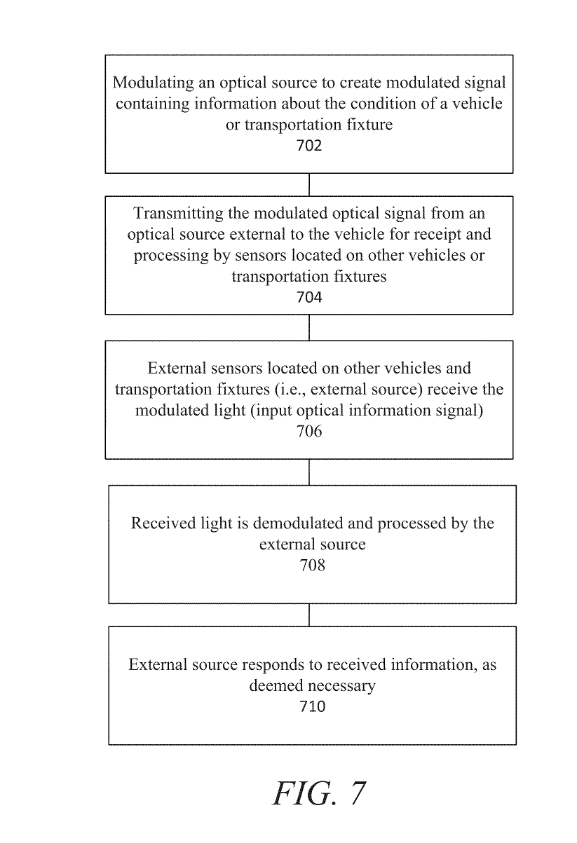

FIG. 7 is a flow diagram illustrating the steps required to facilitate basic communication between two vehicles or vehicle and a transportation fixture. In summary, a modulated optical light signal is first generated for communicating certain information about the condition of the vehicle or fixture, at 702. The modulated light signal is then transmitted external to the vehicle, at 704 using a optical light source. Surrounding transportation fixtures or vehicles may be then receive the modulated optical light signal, at 706, and demodulate the light signal and process the information received from demodulating light signal, at 708. As necessary, operation of the vehicle or the transportation fixture may then be adjusted based upon the received information, at 710.

Optionally, and as illustrated in connection with FIGS. 1-6, structured infrared light may also be emitted by the light source for detection by an on-board sensor or camera to determine the identity, distance and physical structure of surrounding objects external to the vehicle. With this information and utilizing on-board software to help interpret the images, the operation of the vehicle may further be altered. For example, the brakes of the vehicle may be applied, a warning signal may be generated or an air bag may be deployed if an impact is detected as being eminent based upon the speed of the vehicle.

For purposes of this application, it should be understood that the system described above could operate a primary means of communicating information between vehicles and fixtures, but is designed generally as a secondary or redundant system to address issues of failure and safety. Further, vehicles could be any moving object, include but no limited to cars, trucks or even aerial or water vehicles. The vehicles are not required to be autonomous or unmanned. The features of the invention may be utilized for additional safety and control in manned vehicles.

While most of the examples above are given in terms of ground vehicles, the application of the IAV system of the invention may be quite effective in commercial airline applications as current flight operations use radar, visual signals and human control both on the ground and in the air. In unmanned aircraft, redundancy of the these systems may be lost and time lags in communications between the air craft and ground control in both manned and unmanned aircraft may reduce effective safety measures. Incorporating the system of the invention in aircraft control communications by replacing current lights systems with LED lighting systems and facilitating communication between the runway and aircraft lights, for example, could increase safety and add further redundancy to air traffic control. In the same manner as illustrated in connection with FIGS. 1-6, aircraft can be equipped with the system and can communicate using illumination sources with other aircraft, ground communications, and can traffic fixtures (e.g., runway lighting, control tower lighting, etc).

As noted above, light may be modulated to convey a wide range of vehicle and fixture information, which may include, but not be limited to, vehicle position, vehicle speed, rate of acceleration, rate of deceleration, direction of travel, braking information, road speed and flow control information. In response to the communication of such information, responses of neighboring vehicles, traffic signals and traffic conditions may be altered.

It will also be noted that the system controllers schematically depicted in FIGS. 1-6 represent one or more modules configured for controlling, monitoring, timing, synchronizing and/or coordinating various functional aspects of the system such as, for example (as seen in FIG. 1), controlling the operation of the modulator 130, demodulator 132, cameras 110, 112, 114, 116, 122, 124, 126, and 128 and the autonomous vehicle or any of its components. The system controllers, such as 134 of FIG. 1, are also configured for processing information received from all the communicating components and for control the operation of the autonomous vehicle based the receipt of such information.

For all such purposes, the system controllers may include a computer-readable medium that includes instructions for performing any of the methods disclosed herein. The system controllers are schematically illustrated as being in signal communication with various components of the system via wired or wireless communication links represented by lines. Also for these purposes, the system controllers may include one or more types of hardware, firmware and/or software, as well as one or more memories and databases. The system controllers typically include a main electronic processor providing overall control, and may include one or more electronic processors configured for dedicated control operations or specific signal processing tasks. The system controllers may also schematically represent all voltage sources not specifically shown, as well as timing controllers, clocks, frequency/waveform generators and the like as needed for controlling the components of the system. The system controllers may also be representative of, of in communication with one or more types of user interface devices, such as user input devices (e.g., keypad, touch screen, mouse, and the like), user output devices (e.g., display screen, printer, visual indicators or alerts, audible indicators or alerts, and the like), a graphical user interface (GUI) controlled by software, and devices for loading media readable by the electronic processor (e.g., logic instructions embodied in software, data, and the like). The system controllers may include an operating system for controlling and managing various functions of the system controllers.

It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

Terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood, and is appreciated by persons skilled in the art, that one or more processes, sub-processes, or process steps described in connection with FIGS. 1-7 may be performed by hardware and/or software. If the process is performed by software, the software may reside in software memory (not shown) in a suitable electronic processing component or system such as, one or more of the functional components or modules schematically depicted in FIGS. 1-7. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions.

In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

1. A method for navigating an autonomous vehicle through an external environment having an external source, where the autonomous vehicle has an optical source, optical sensor, modulator, demodulator, processor, and navigation system, the method comprising:
modulating the optical source with the modulator to create a modulated optical signal, wherein the optical source is modulated with a modulating signal;
transmitting the modulated optical signal from the optical source to an the external environment of the vehicle; and
receiving an input optical information signal from the external environment with the optical sensor, wherein the input optical information signal includes information about the external source;
processing the input optical information with a processor to produce processed data; and
navigating the autonomous vehicle, with the navigation system, through the external environment based on the processed data.

2. The method of claim 1, transmitting the modulated optical signal includes transmitting information to a transportation fixture.

3. The method of claim 1 where the optical source also functions as either a headlight or a taillight illuminating the external environment.

4. The method of claim 1 where the external source is another vehicle or a transportation fixture.

5. The method of claim 1 where the input optical information signal includes information selected from the group consisting of communication information, obstacle avoidance information, and imaging information.

6. The method of claim 1 further comprising determining if a vehicle response is needed in view of the received information about the external source.

7. the method of claim 6 wherein receiving the optical information signal includes receiving traffic information from the external source.

8. The method of claim 1 further comprising transmitting structured light from an optical source to the external environment.

9. The method of claim 8 further comprising receiving image information from the input optical information signal to determine a three-dimensional shape of an object in the external environment.

10. The method of claim 1 wherein the receiving the optical information signal includes receiving image information with a camera.

11. A method of communication and obstacle avoidance with an optical source in an autonomous vehicle, the method comprising:
transmitting a modulated optical signal having vehicle information from the optical source to an external environment of the autonomous vehicle;
receiving an input optical information signal from the external environment at an optical sensor of the autonomous vehicle,
wherein the input optical information signal includes information selected from the group consisting of communication information, obstacle avoidance information, and imaging information;
processing the input optical information signal with a processor to produce navigation information; and
navigating the autonomous vehicle, with a navigation system, through the external environment based on the navigation information.

12. The method of claim 11, wherein processing the input optical information signal includes demodulating the input optical information signal to produce a received input signal, and
further including establishing a communication link with an external object in the external environment using the received input signal.

13. The method of claim 12, wherein the external object is another autonomous vehicle or a transportation fixture.

14. The method of claim 13, wherein the roadside fixture is a traffic signal.

15. The method of claim 13, further including transmitting headlight illumination from the optical source.

16. The method of claim 13, further including transmitting braking illumination from the optical source.

17. The method of claim 16, further including transmitting turn indication illumination from the optical source.

18. The method of claim 11, further including transmitting structured light illumination from the optical source to the external environment.

19. The method of claim 18, further including utilizing the received imaging information from the input optical information to determine a three-dimensional shape of an object in the external environment.

20. A navigation system for navigating an autonomous vehicle through an external environment having objects external to the autonomous vehicle, the navigation system comprising:
an optical source, wherein the optical source is configured to illuminate, with visible light, external environment to the autonomous vehicle;
a modulator in signal communication with the optical source,
wherein the modulator is configured to create a modulated optical signal that includes information about the autonomous vehicle,
wherein the optical source is configured to transmit the modulated optical signal to the external environment, and
wherein the information contains information about the current operation of the autonomous vehicle;
an optical sensor for receiving input optical information signals from the objects;
a processor, wherein the processor is configured to process the input optical information to produce processed data; and
a navigation system configured to navigate the autonomous vehicle through the external environment based on the processed data.

21. The navigation system of claim 20 wherein the information about the current operation of the vehicle includes information selected from the group consisting of identification information, current speed, rate of acceleration, rate of deceleration, braking information, directional information, and location information.

22. The navigation system of claim 20 further comprising an optical light source for transmitting structured infrared light to the external environment.

23. The navigation system of claim 20 further comprising a plurality of optical sensors for receiving the input optical information signal from the external environment.

24. The navigation system of claim 20 a demodulator for demodulating the received input optical information signals and produce a demodulated received input optical information signal,
wherein the demodulator is in signal communication with the optical sensor, and
wherein the processor is configured to process the demodulated received input optical information signal to produce the processed data.
